(19) United States
(12) Patent Application Publication
(10) Pub. No.: US 2017/0003733 A1
(43) Pub. Date: Jan. 5, 2017

(54) POWER AMPLIFIER WITH GENERAL PURPOSE INPUT OUTPUT MODULE

(71) Applicant: SKYWORKS SOLUTIONS, INC., Woburn, MA (US)

(72) Inventor: Matthew Lee BANOWETZ, Marion, IA (US)

(21) Appl. No.: 15/143,478

(22) Filed: Apr. 29, 2016

Related U.S. Application Data
(60) Provisional application No. 62/155,035, filed on Apr. 30, 2015.

(51) Int. Cl. G06F 1/32; G06F 13/40; G06F 13/42

(52) U.S. Cl. CPC G06F 1/3287; G06F 1/3296; G06F 13/4282; G06F 13/4022; H04B 2001/0408

(57) ABSTRACT

Systems, devices and methods related to configuring a power amplifier. In some embodiments, a power amplifier may include a general purpose input output (GPIO) lines and a GPIO module. The GPIO module may allow the power amplifier to configure the GPIO lines. Configuring the GPIO lines may allow the PA to have a common design that may be configured or reconfigured to interface with and/or control different types of electronic components.

### CROSS-REFERENCE TO RELATED APPLICATIONS

This application claims priority to U.S. Provisional Application No. 62/155,035 filed Apr. 30, 2015, entitled POWER AMPLIFIER WITH GENERAL PURPOSE INPUT OUTPUT MODULE. The contents of each of the above-referenced application(s) are hereby expressly incorporated by reference herein in their entireties for all purposes.

### BACKGROUND

Field

The present disclosure generally relates to power amplifiers.

Description of the Related Art

Power amplifiers are widely used in various communication networks to set the transmission power level of an information-bearing signal transmitted by a device. For example, power amplifiers are used to set the pulse energy emitted by pulsed lasers in optical communication networks. Power amplifiers are also used in the radio frequency (RF) front end components of wireless carrier network devices—such as base stations, repeaters, and mobile devices—to set the power level of a signal transmitted through an antenna. Power amplifiers are also used in local area networks to support both wired and wireless connectivity of servers, computers, laptops, and peripheral devices.

### SUMMARY

In some implementations, the present disclosure relates to a power amplifier (PA) module. The power amplifier module includes a PA circuit configured to receive a radio-frequency (RF) signal. The power amplifier module also includes a general purpose input output (GPIO) module coupled to the PA circuit, the GPIO module configured to configure a set of GPIO lines to interface with an electronic component and the set of GPIO lines configured to provide one or more of a control signal, a current, or a voltage to the electronic component via the one or more GPIO lines.

In some embodiments, the control signal indicates one or more of a first voltage level of a logical high state or a second voltage level of a logical low state.

In some embodiments, the set of GPIO lines is coupled to a digital to analog converter (DAC).

In some embodiments, the current is received from a current source coupled to the set of GPIO lines.

In some embodiments, the voltage is received from a voltage source coupled to the set of GPIO lines.

In some embodiments, the set of GPIO lines is configured based on first data received via a serial peripheral interface.

In some embodiments, the first data is received while the PA module is in operation.

In some embodiments, the first data is received prior to the operation of the PA module.

In some embodiments, the electronic component includes an antenna switching module (ASM).

In some embodiments, the electronic component includes a band switch.

In some embodiments, the electronic component includes a direct current to direct current converter.

In some embodiments, the electronic component includes a bolt on PA.

In some embodiments, the PA module includes a multimode multiband (MMMB) PA.

In some implementations, the present disclosure relates to a method of operating a power amplifier (PA) module. The method includes receiving first data indicative of a configuration of a set of general purpose input output (GPIO) lines of a GPIO module. The method also includes configuring the set of GPIO lines based on the first data, the set of GPIO lines being coupled to an electronic component and the set of GPIO lines configured to provide one or more of a control signal, a current, or a voltage to the electronic component via the one or more GPIO lines.

In some embodiments, the control signal indicates one or more of a first voltage level of a logical high state or a second voltage level of a logical low state.

In some embodiments, the set of GPIO lines is coupled to a digital to analog converter (DAC).

In some embodiments, the current is received from a current source coupled to the set of GPIO lines.

In some embodiments, the voltage is received from a voltage source coupled to the set of GPIO lines.

In some embodiments, the set of GPIO lines is configured based on first data received via a serial peripheral interface.

In some embodiments, the first data is received while the PA module is in operation.

In some embodiments, the first data is received prior to the operation of the PA module.

In some embodiments, the electronic component includes an antenna switching module (ASM).

In some embodiments, the electronic component includes a band switch.

In some embodiments, the electronic component includes a direct current to direct current converter.

In some embodiments, the electronic component includes a bolt on PA.

In some embodiments, the PA module includes a multimode multiband (MMMB) PA.

In some implementations, the present disclosure relates to a power amplifier (PA) die. The power amplifier die includes a semiconductor substrate. The power amplifier die also includes a PA circuit implemented on the semiconductor substrate, the PA circuit configured to receive radio-frequency (RF) signal. The power amplifier die further includes a general purpose input output (GPIO) module implemented on the semiconductor substrate, the GPIO module coupled to the PA circuit and configured to configure a set of GPIO lines to interface with an electronic component, the set of GPIO lines configured to provide one or more of a control signal, a current, or a voltage to the electronic component via the one or more GPIO lines.

In some implementations, the present disclosure relates to power amplifier module. The power amplifier module includes a packaging substrate configured to receive a plurality of components. The power amplifier module also includes a power amplifier (PA) circuit formed on a die that is mounted on the packaging substrate, the PA circuit configured to receive a radio-frequency (RF) signal. The power amplifier module further includes a general purpose input output (GPIO) module formed on the die, the GPIO module coupled with the PA circuit and configured to configure a set of GPIO lines to interface with an electronic component, the set of GPIO lines configured to provide one or more of a control signal, a current, or a voltage to the electronic component via the one or more GPIO lines.

In some implementations, the present disclosure relates to an electronic device. The electronic device includes a transceiver configured to generate a radio-frequency (RF) signal. The electronic device also includes a power amplifier (PA) module in communication with the transceiver and configured to amplify the RF signal, the PA module including a PA circuit and general purpose input output (GPIO) module configured to configure a set of GPIO lines to interface with an electronic component, the set of GPIO lines configured to provide one or more of a control signal, a current, or a voltage to the electronic component via the one or more GPIO lines. The electronic device further includes an antenna in communication with the PA module, the antenna configured to facilitate transmission of the amplified RF signal.

In some implementations, the present disclosure relates to a method of fabricating a radio-frequency (RF) module. The method includes providing a packaging substrate having a surface, the packaging substrate configured to receive a plurality of components on the surface. The method also includes mounting a power amplifier (PA) circuit on the surface of the packaging substrate. The method further includes mounting a general purpose input output (GPIO) module on the surface of the packaging substrate, the GPIO module configured to configure a set of GPIO lines to interface with an electronic component, the set of GPIO lines configured to provide one or more of a control signal, a current, or a voltage to the electronic component via the one or more GPIO lines. The method further includes coupling the GPIO module with the PA circuit.

### BRIEF DESCRIPTION OF THE DRAWINGS

FIG. 1 is a block diagram illustrating a wireless system or architecture, according to one embodiment of the present disclosure.

FIG. 2 is a block diagram illustrating an amplification system, according to one embodiment of the present disclosure.

FIGS. 3A-3E are block diagrams illustrating examples of power amplifiers, according to some embodiments of the present disclosure.

FIG. 4 is a block diagram illustrating an amplification system, according to one embodiment of the present disclosure.

FIG. 5 is a block diagram illustrating a power amplifier, according to one embodiment of the present disclosure.

FIGS. 6A-6G are block diagrams illustrating example power amplifiers, according to some embodiments of the present disclosure.

FIGS. 7A-7D are block diagrams illustrating examples of implementations/configurations of power amplifiers on one or more semiconductor die, according to some embodiments of the present disclosure.

FIG. 8 is a block diagram illustrating an example power amplification system, according to one embodiment of the present disclosure.

FIG. 9 depicts an example wireless device 400, according to one embodiment of the present disclosure.

FIG. 10 shows a flowchart representation of a method of configuring one or more GPIO lines, according to some embodiments of the present disclosure.

FIG. 11 shows a flowchart representation of a method 1100 of fabricating a power amplifier, according to some embodiments of the present disclosure.

### DETAILED DESCRIPTION OF SOME EMBODIMENTS

The headings provided herein, if any, are for convenience only and do not necessarily affect the scope or meaning of the disclosure. While pertinent features are illustrated, those skilled in the art will appreciate from the present disclosure that various other features have not been illustrated for the sake of brevity and so as not to obscure more pertinent aspects of the example implementations disclosed herein.

### Introduction:

Power amplifiers are used in communication networks to set the transmission level of data signals. For example, power amplifiers are used to set transmission pulse laser energy in optical communication networks. Power amplifiers are used in radio frequency (RF) components of wireless devices (e.g., base stations and mobile devices) to set the power level transmitted through an antenna. Power amplifiers are also used in local area networks to support connectivity of servers, computers, laptops, and peripheral devices.

Referring to FIG. 1, one or more features of the present disclosure generally relate to a wireless system or architecture 50 having an amplification system 52. In some embodiments, the amplification system 52 can be implemented as one or more devices (e.g., one or more power amplifiers (PAs)), and such device(s) can be utilized in the wireless system/architecture 50. In some embodiments, the amplification system may be a system (e.g., one or more devices) that increase the power of a signal. For example, the amplification system 52 may convert (e.g., amplify) a low-power radio-frequency signal into a higher-power signal. In some embodiments, the wireless system/architecture 50 can be implemented in, for example, a portable wireless device. Examples of such a wireless device are described herein.

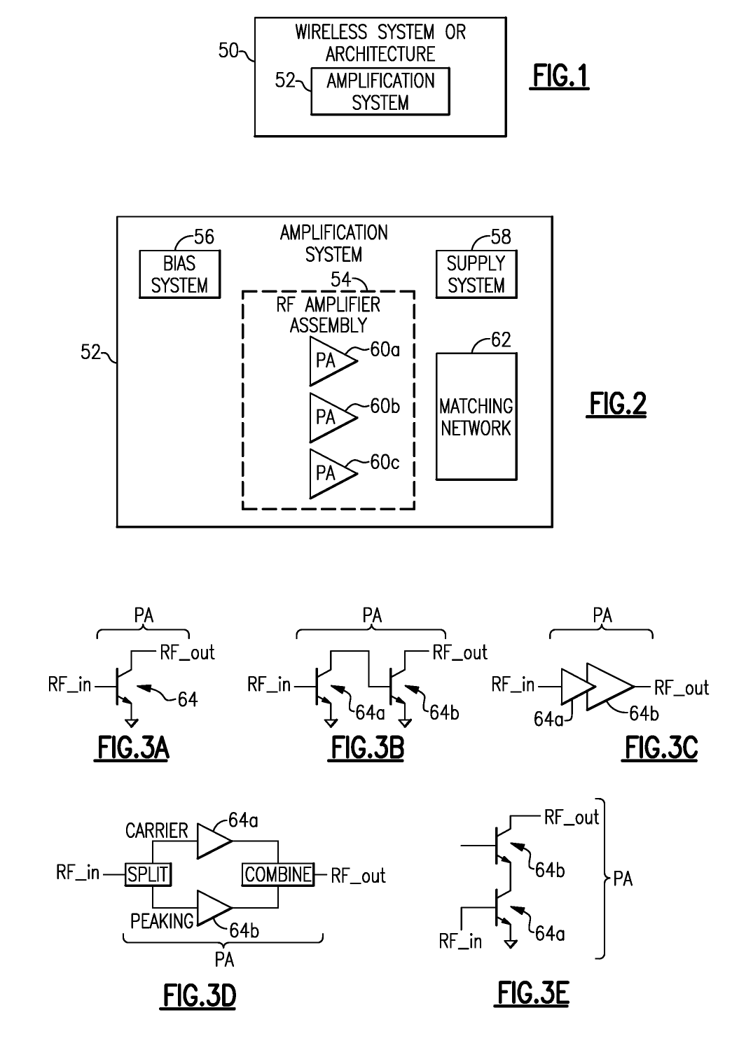

FIG. 2 shows that the amplification system 52 of FIG. 1 typically includes a radio-frequency (RF) amplifier assembly 54 having one or more power amplifiers (PAs). In the example of FIG. 2, three PAs 60a-60c are depicted as forming the RF amplifier assembly 54. It will be understood that other numbers of PA(s) can also be implemented. It will also be understood that one or more features of the present disclosure can also be implemented in RF amplifier assemblies having other types of RF amplifiers.

In some embodiments, the RF amplifier assembly 54 can be implemented on one or more semiconductor die, and such die can be included in a packaged module such as a power amplifier module (PAM) or a front-end module (FEM). Such a packaged module is typically mounted on a circuit board associated with, for example, a portable wireless device.

The PAs (e.g., 60a-60c) in the amplification system 52 are typically biased by a bias system 56. Further, supply voltages for the PAs are typically provided by a supply system 58. In some embodiments, either or both of the bias system 56 and the supply system 58 can be included in the foregoing packaged module having the RF amplifier assembly 54. The bias system 56 and/or the supply system 58 may also include one or more power amplifiers.

In some embodiments, the amplification system 52 can include a matching network 62. Such a matching network can be configured to provide input matching and/or output matching functionalities for the RF amplifier assembly 54.

In some embodiments, the PAs (e.g., 60a-60c) may be multimode multiband (MMMB) PAs. A MMMB PA may allow an electronic devices (e.g., a smartphone, a cellular phone, a table computer, a laptop computer, etc.) to transmit and/or receive signals at different RF frequencies.

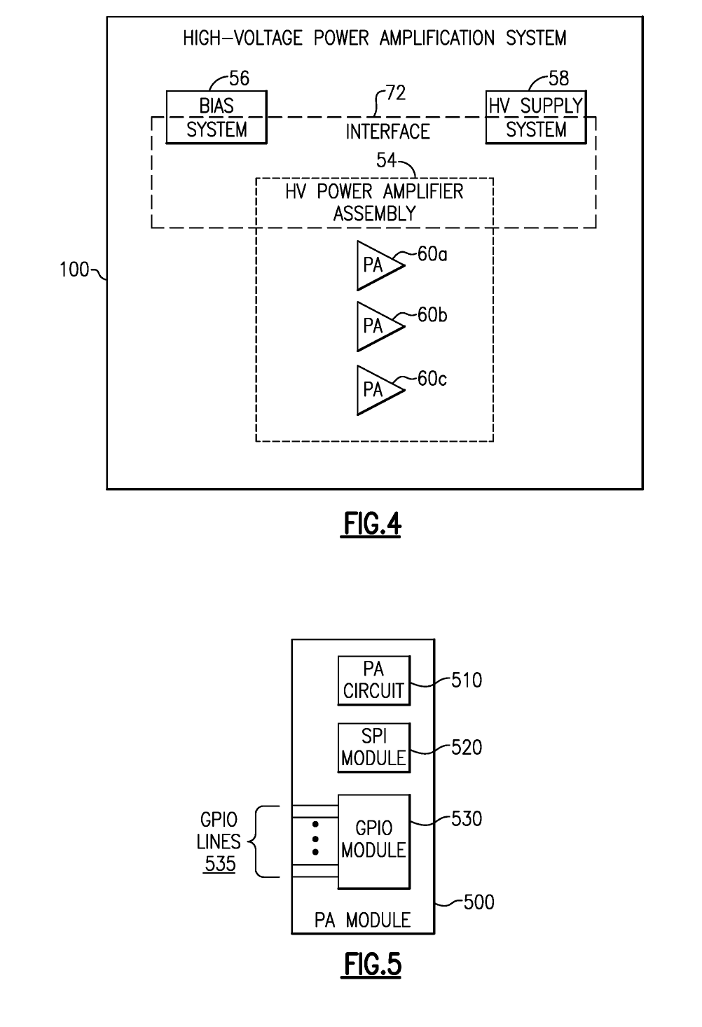

For the purpose of description, it will be understood that each PA (60) of FIG. 2 can be implemented in a number of ways. FIGS. 3A-3E show non-limiting examples of how such a PA can be configured. FIG. 3A shows an example PA having an amplifying transistor 64, where an input RF signal (RF_in) is provided to a base of the transistor 64, and an amplified RF signal (RF_out) is output through a collector of the transistor 64. As discussed above, the PA may be a MMMB PA.

FIG. 3B shows an example PA having a plurality of amplifying transistors (e.g., 64a, 64b) arranged in stages. An input RF signal (RF_in) is provided to a base of the first transistor 64a, and an amplified RF signal from the first transistor 64a is output through its collector. The amplified RF signal from the first transistor 64a is provided to a base of the second transistor 64b, and an amplified RF signal from the second transistor 64b is output through its collector to thereby yield an output RF signal (RF_out) of the PA. As discussed above, the PA may be a MMMB PA.

In some embodiments, the foregoing example PA configuration of FIG. 3B can be depicted as two or more stages as shown in FIG. 3C. The first stage 64a can be configured as, for example, a driver stage; and the second stage 64b can be configured as, for example, an output stage. As discussed above, the PA may be a MMMB PA.

FIG. 3D shows that in some embodiments, a PA can be configured as a Doherty PA. Such a Doherty PA can include amplifying transistors 64a, 64b configured to provide carrier amplification and peaking amplification of an input RF signal (RF_in) to yield an amplified output RF signal (RF_out). The input RF signal can be split into the carrier portion and the peaking portion by a splitter. The amplified carrier and peaking signals can be combined to yield the output RF signal by a combiner. As discussed above, the PA may be a MMMB PA.

FIG. 3E shows that in some embodiments, a PA can be implemented in a cascade configuration. An input RF signal (RF_in) can be provided to a base of the first amplifying transistor 64a operated as a common emitter device. The output of the first amplifying transistor 64a can be provided through its collector and be provided to an emitter of the second amplifying transistor 64b operated as a common base device. The output of the second amplifying transistor 64b can be provided through its collector so as to yield an amplified output RF signal (RF_out) of the PA. As discussed above, the PA may be a MMMB PA.

In the various examples of FIGS. 3A-3E, the amplifying transistors are described as bipolar junction transistors (BJTs) such as heterojunction bipolar transistors (HBTs). It will be understood that one or more features of the present disclosure can also be implemented in or with other types of transistors such as field-effect transistors (FETs).

FIG. 4 shows that in some embodiments, the amplification system 52 of FIG. 2 can be implemented as a high-voltage (HV) power amplification system 70. Such a system can include an HV power amplifier assembly 54 configured to include HV amplification operation of some or all of the PAs (e.g., 60a-60c). As discussed above, one or more of the PAs (e.g., 60a-60c) may be MMMB PAs. As described herein, such PAs can be biased by a bias system 56. In some embodiments, the foregoing HV amplification operation can be facilitated by an HV supply system 58. In some embodiments, an interface system 72 can be implemented to provide interface functionalities between the HV power amplifier assembly 54 and either or both of the bias system 56 and the HV supply system 58.

FIG. 5 is a block diagram illustrating a PA 500 according to one embodiment of the present disclosure. As illustrated in FIG. 5, the PA 500 includes a PA circuit, 510, a serial peripheral interface (SPI) module 520, a general purpose input/output (GPIO) module 530, and one or more GPIO lines 535 (e.g., wires, pins, traces, etc.). In one embodiment, the PA 500 may be a MMMB PA. The PA 500 may also be referred to as a PA module or a MMMB PA module.

PAs may be used in various applications and/or configurations within an electronic device (e.g., a smartphone, cellular phone, tablet computer, laptop computer, etc.). For example, a PA may be coupled to various electronic components such as antenna switch modules (ASMs), band switches (BSs), DC/DC converters, bolt on PAs, etc. The PA may interface with (e.g., communicate with and/or control) different electronic components in different ways. For example, a first electronic component may receive a current as an input from the PA and a second electronic component may receive a voltage as an input from the PA. In addition, different electronic components may allow the PA to control the different electronic components using different control signals. A PA with configurable GPIO lines may allow the PA to have a common design that may be configured (or reconfigured) to interface with and/or control different types of electronic components including, but not limited to, ASMs, BSs, DC/DC converters, and bolt on PAs. For example, a single PA (e.g., a single PA design) may be used to interface with and/or control an ASM, a BS, a bolt on PA, etc.

The PA circuit 510 may be one or more circuits, components, modules, devices, etc., that may perform power amplification functions. For example, the PA circuit 510 may be configured as illustrated and discussed above in conjunction with FIGS. 3A-3E.

As discussed above, the PA module 500 includes GPIO lines 535 (e.g., a set of GPIO lines). The GPIO lines 535 may be lines, wires, traces, pins, etc., that may be used to provide/receive a current, provide/receive a voltage, and/or transmit/receive signals (e.g., binary signals, control signals, etc.). The GPIO lines 535 may be configured as both input lines and/or output lines. The GPIO lines may also be individually enabled and/or disabled.

The GPIO module 530 may configure (e.g., set up) the one or more GPIO lines 535 such that the PA module 500 may interface with and/or control different electronic components using the GPIO lines. For example, the GPIO module 530 may configure one or more of the GPIO lines 535 to receive a voltage from a voltage source and to provide the voltage to an electronic component (as discussed in more detail below). In another example, the GPIO module 530 may configure one or more of the GPIO lines 535 to receive a current from a current source and to provide the current to an electronic component (as discussed in more detail below). In a further example, the GPIO module 530 may configure the GPIO lines 535 to provide a first voltage level for a logical high state to an electronic component (as discussed in more detail below). The GPIO module 530 may be any combination of hardware (e.g., one or more circuits), software, and firmware that may configure the GPIO lines 535. In one embodiment, the GPIO module 530 may configure the GPIO lines 535 prior to the operation of the PA 500. In another embodiment, the GPIO module 530 may configure the GPIO lines 535 during the operation of the PA 500 (e.g., while the PA 500 is in operation).

The GPIO module 530 may receive data, signals, messages, frames, etc., indicating how to configure the GPIO lines 535 from the SPI module 520. The SPI module 520 may be coupled to a computing device (or another machine) via a SPI interface. In one embodiment, the SPI module 520 may receive the data, signals, messages, frames, etc., via the SPI interface and may provide the data, signals, messages, frames, etc., to the GPIO module 530. The GPIO module 530 may configure the GPIO lines 535 based on the data, signals, messages, frames, etc. In another embodiment, the SPI module 520 may transmit additional instructions (e.g., instructions indicating how to configured the GPIO lines 535) to the GPIO module 530 to configure the GPIO lines 535 based on the data, signals, messages, frames, etc.

The GPIO module 530, the GPIO lines 535, and/or the SPI module 520 may allow the PA 500 to apply signals (e.g., control signals) that control the logic or operation of ASMs and/or BSs. The GPIO module 530, the GPIO lines 535, and/or the SPI module 520 may also allow the PA 500 to control the logic or operation of a DC/DC converter The GPIO module 530, the GPIO lines 535, and/or the SPI module 520 may further allow the PA 500 to control the analog input for a DC/DC converter. The GPIO module 530, the GPIO lines 535, and/or the SPI module 520 may also allow the PA 500 to bias a bolt on PA that may use different voltages to bias the bolt on PA.

The PA module of 500 (with the GPIO module 530, the GPIO lines 535, and/or the SPI module 520) may reduce the number of discrete logic and control signals that come from a transceiver and/or baseband processor. The GPIO module 530, the GPIO lines 535, and/or the SPI module 520 may allow the PA 500 to control the peripheral devices and/or components (e.g., electronic devices and/or components) that may be coupled to the PA 500 and/or may be near the PA 500. This may allow for greater flexibility when coupling, integrating, and/or interfacing the PA 500 with different electronic components for different configurations and/or applications.

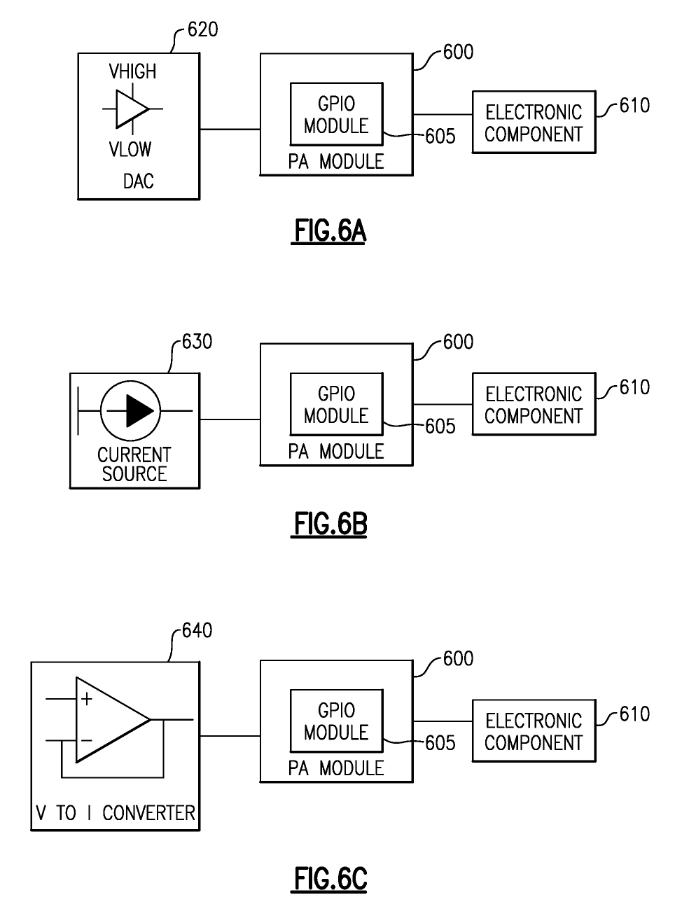

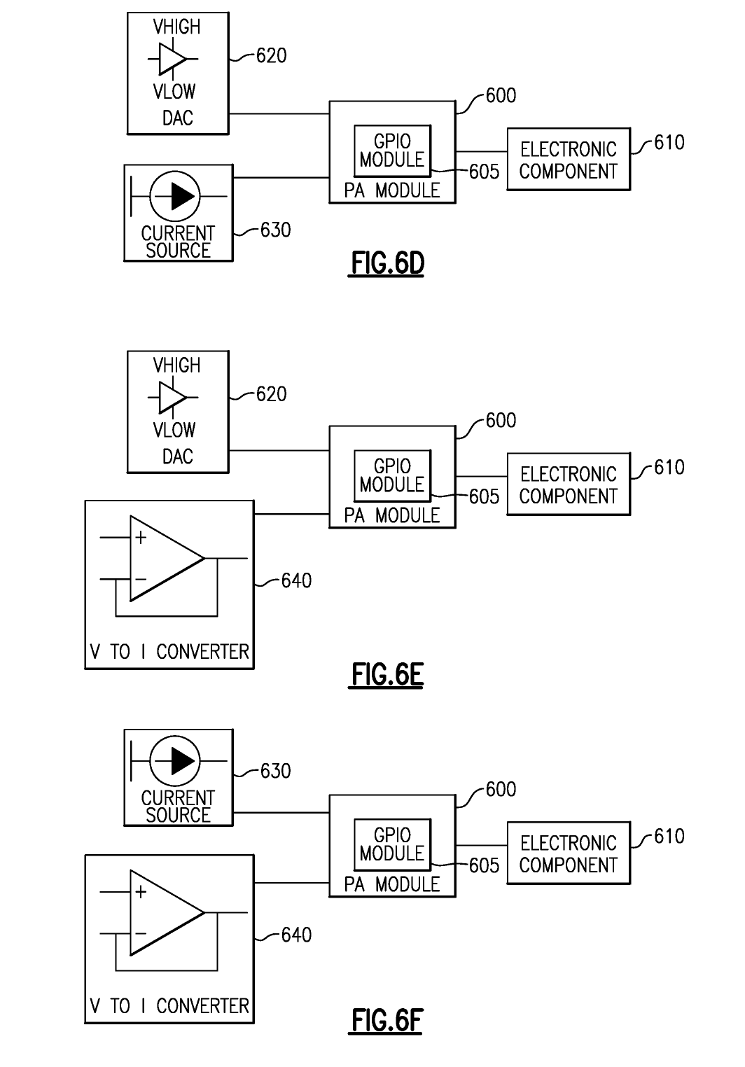

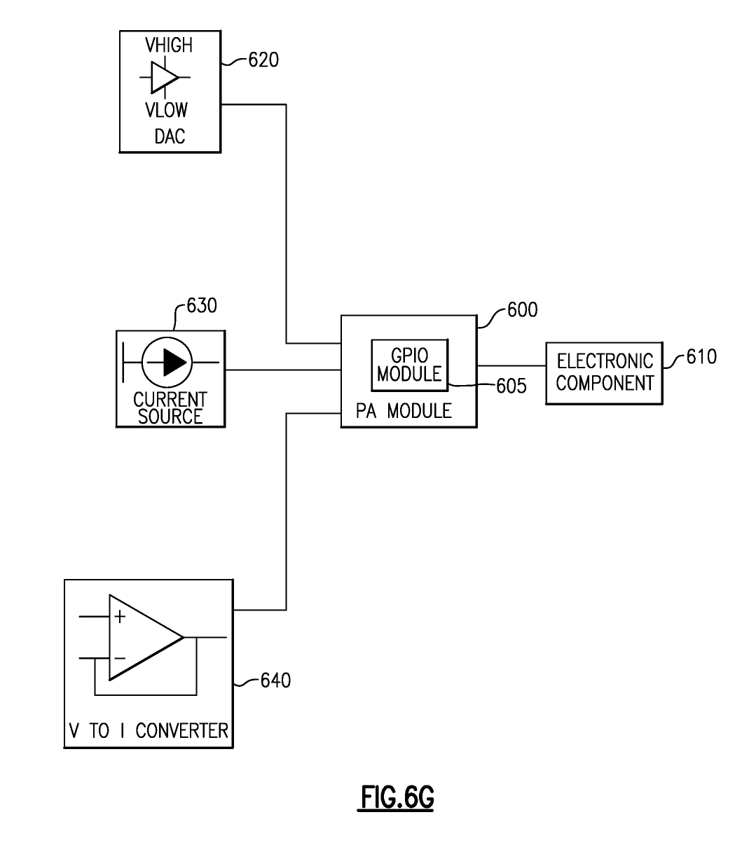

FIG. 6A is a block diagram illustrating a PA 600 according to one embodiment of the present disclosure. The PA 600 includes a GPIO module 605. As discussed above, the PA 600 may perform power amplification functions. The GPIO module 605 may configure one or more GPIO lines based on data received from a SPI interface, as discussed above. In one embodiment, the PA 600 may be an MMMB PA.

The PA 600 is coupled to an electronic component 610. The electronic component 610 may be any component, circuit, module, and/or device that may operate in conjunction with the PA 600. For example, the electronic component 610 may be a device that receives an amplified signal from the PA 600. Examples of electronic components include, but are not limited to, an ASM, a BS, a bolt on PA, etc.

The PA 600 is also coupled to a digital to analog converter (DAC) 620. The DAC 620 may be a component, circuit, module, and/or device that may convert digital data (e.g., binary data) into an analog signal (e.g., a voltage, a current, an electric charge, etc.). The DAC 620 may be used to generate a first voltage that may represent a logical high state (e.g., a “1”) and/or may be used to generate a second voltage that may represent a logical low state (e.g., a “0”). For example, DAC 620 may generate a first voltage V_{batt} (e.g., the voltage of a battery) and a second voltage of zero volts or ground. The voltages that represent the logical high state and/or logical low state may be referred to as control signals. The GPIO module 610 may configure the GPIO lines to control the DAC 620 (e.g., to control the voltages that represent the logical high state and/or logical low state). The GPIO module 610 may provide the voltages that represent the logical high state and/or logical low state to the electronic component 610. This may allow the PA 600 to control the voltages used by the electronic component 610 to represent the logical high state and/or logical low state.

FIG. 6B is a block diagram illustrating a PA 600 according to one embodiment of the present disclosure. The PA 600 includes a GPIO module 605. As discussed above, the PA 600 may perform power amplification functions. The GPIO module 605 may configure one or more GPIO lines based on data received from a SPI interface, as discussed above. In one embodiment, the PA 600 may be an MMMB PA. The PA 600 is coupled to an electronic component 610. The electronic component 610 may be any component, circuit, module, and/or device that may operate in conjunction with the PA 600 (e.g., an ASM, a BS, a bolt on PA, etc.).

The PA 600 is also coupled to a current source 630. The current source 630 may be any component, module, circuit, and/or device that may be used to generate a current. For example, the current source 630 may be a digitally programmed DAC. In another example, the current source 630 may be an analog current source. In a further example, a V to I converter may be used to produce a current. The V to I converter may be controlled by the PA 600. For example, the GPIO module 605 and/or an SPI module may control the V to I converter via the GPIO lines of the PA 600. This may allow the electronic component 610 to use the current provided by the PA 600. This may also may reduce the complexity of the wiring and circuitry of the electronic component 610 because the electronic component may not be coupled to a separate current source.

FIG. 6C is a block diagram illustrating a PA 600 according to one embodiment of the present disclosure. The PA 600 includes a GPIO module 605. As discussed above, the PA 600 may perform power amplification functions. The GPIO module 605 may configure one or more GPIO lines (not shown in FIG. 6A) based on data received from a SPI interface (not shown in FIG. 6A), as discussed above. In one embodiment, the PA 600 may be an MMMB PA. The PA 600 is coupled to an electronic component 610. The electronic component 610 may be any component, circuit, module, and/or device that may operate in conjunction with the PA 600 (e.g., an ASM, a BS, a bolt on PA, etc.).

The PA 600 is also coupled to a voltage source 640. The voltage source 640 may be any component, module, circuit, and/or device that may be used to generate a voltage. For example, the voltage source 640 may be an I to V converter. The I to V converter may be controlled by the PA 600. For example, the GPIO module 605 and/or an SPI module may control the I to V converter via the GPIO lines of the PA 600. This may allow the electronic component 610 to use the voltage provided by the PA 600 which may reduce the complexity of the wiring and circuitry of the electronic component 610 because the electronic component may not be coupled to a separate voltage source. This may also allow PA 600 to provide one or more bias voltages to the electronic component 610 if the electronic component 610 uses bias voltages.

FIG. 6D is a block diagram illustrating a PA 600 according to one embodiment of the present disclosure. The PA 600 includes a GPIO module 605. As discussed above, the PA 600 may perform power amplification functions. The GPIO module 605 may configure one or more GPIO lines based on data received from a SPI interface, as discussed above. In one embodiment, the PA 600 may be an MMMB PA. The PA 600 is coupled to an electronic component 610. The electronic component 610 may be any component, circuit, module, and/or device that may operate in conjunction with the PA 600 (e.g., an ASM, a BS, a bolt on PA, etc.).

As illustrated in FIG. 6D, the PA 600 is also coupled to DAC 620 and current source 630. As discussed above, the DAC 620 may be used to generate voltages that represent a logical high state and/or a logical low state. The PA 600 may provide the voltages that represent a logical high state and/or a logical low state to the electronic component 610 via one or more GPIO lines. The current source 630 may be any component, module, circuit, and/or device (e.g., a V to I converter) that may be used to generate a current. The PA 600 may provide the current received from the current source 630 to the electronic component 610 via the one or more GPIO lines.

FIG. 6E is a block diagram illustrating a PA 600 according to one embodiment of the present disclosure. The PA 600 includes a GPIO module 605. As discussed above, the PA 600 may perform power amplification functions. The GPIO module 605 may configure one or more GPIO lines based on data received from a SPI interface, as discussed above. In one embodiment, the PA 600 may be an MMMB PA. The PA 600 is coupled to an electronic component 610. The electronic component 610 may be any component, circuit, module, and/or device that may operate in conjunction with the PA 600 (e.g., an ASM, a BS, a bolt on PA, etc.).

As illustrated in FIG. 6E, the PA 600 is also coupled to DAC 620 and voltage source 640. As discussed above, the DAC 620 may be used to generate voltages that represent a logical high state and/or a logical low state. The PA 600 may provide the voltages that represent a logical high state and/or a logical low state to the electronic component 610 via one or more GPIO lines. The voltage source 640 may be any component, module, circuit, and/or device (e.g., an I to V converter) that may be used to generate a voltage. The PA 600 may provide the voltage received from the voltage source 640 to the electronic component 610 via the one or more GPIO lines.

FIG. 6F is a block diagram illustrating a PA 600 according to one embodiment of the present disclosure. The PA 600 includes a GPIO module 605. As discussed above, the PA 600 may perform power amplification functions. The GPIO module 605 may configure one or more GPIO lines (not shown in FIG. 6A) based on data received from a SPI interface (not shown in FIG. 6A), as discussed above. In one embodiment, the PA 600 may be an MMMB PA. The PA 600 is coupled to an electronic component 610. The electronic component 610 may be any component, circuit, module, and/or device that may operate in conjunction with the PA 600 (e.g., an ASM, a BS, a bolt on PA, etc.).

The PA 600 is also coupled to a current source 630 and a voltage source 640. The current source 630 may be any component, module, circuit, and/or device (e.g., a V to I converter) that may be used to generate a current. The PA 600 may provide the current received from the current source 630 to the electronic component 610 via the one or more GPIO lines. The voltage source 640 may be any component, module, circuit, and/or device (e.g., an I to V converter) that may be used to generate a voltage. The PA 600 may provide the voltage received from the voltage source 640 to the electronic component 610 via the one or more GPIO lines.

FIG. 6G is a block diagram illustrating a PA 600 according to one embodiment of the present disclosure. The PA 600 includes a GPIO module 605. As discussed above, the PA 600 may perform power amplification functions. The GPIO module 605 may configure one or more GPIO lines (not shown in FIG. 6A) based on data received from a SPI interface (not shown in FIG. 6A), as discussed above. In one embodiment, the PA 600 may be an MMMB PA. The PA 600 is coupled to an electronic component 610. The electronic component 610 may be any component, circuit, module, and/or device that may operate in conjunction with the PA 600 (e.g., an ASM, a BS, a bolt on PA, etc.).

The PA 600 is also coupled to a DAC 620, a current source 630, and a voltage source 640. As discussed above, the DAC 620 may be used to generate voltages that represent a logical high state and/or a logical low state. The PA 600 may provide the voltages that represent a logical high state and/or a logical low state to the electronic component 610 via one or more GPIO lines. The current source 630 may be any component, module, circuit, and/or device (e.g., a V to I converter) that may be used to generate a current. The PA 600 may provide the current received from the current source 630 to the electronic component 610 via the one or more GPIO lines. The voltage source 640 may be any component, module, circuit, and/or device (e.g., an I to V converter) that may be used to generate a voltage. The PA 600 may provide the voltage received from the voltage source 640 to the electronic component 610 via the one or more GPIO lines.

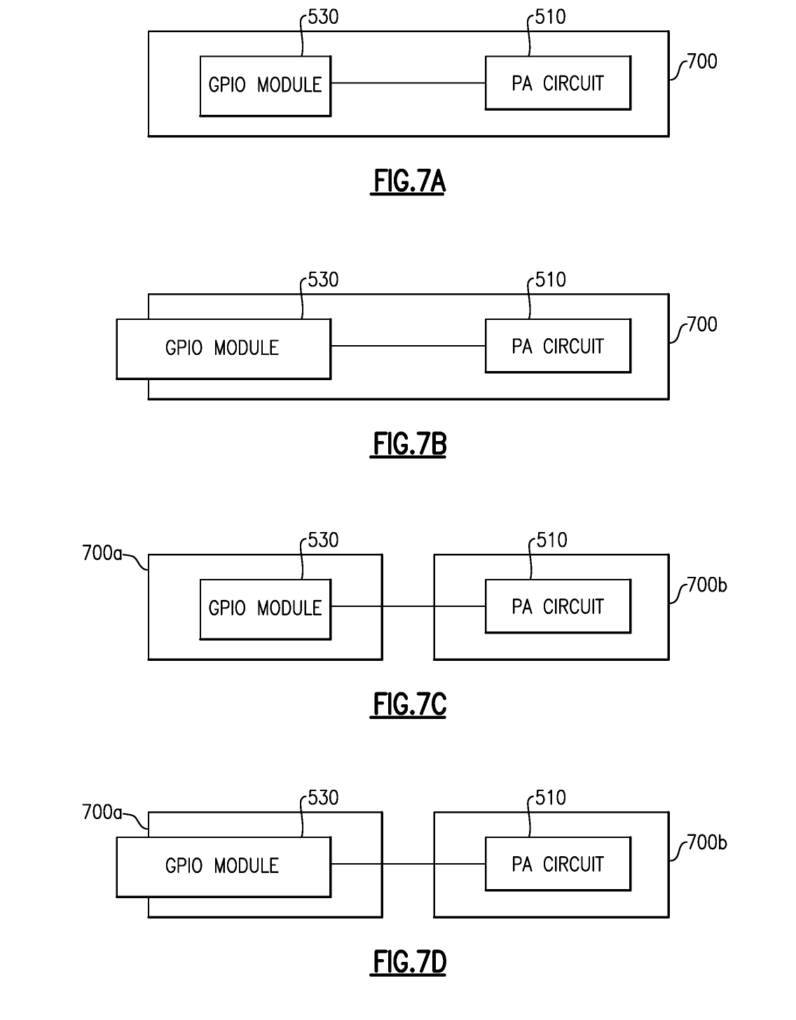

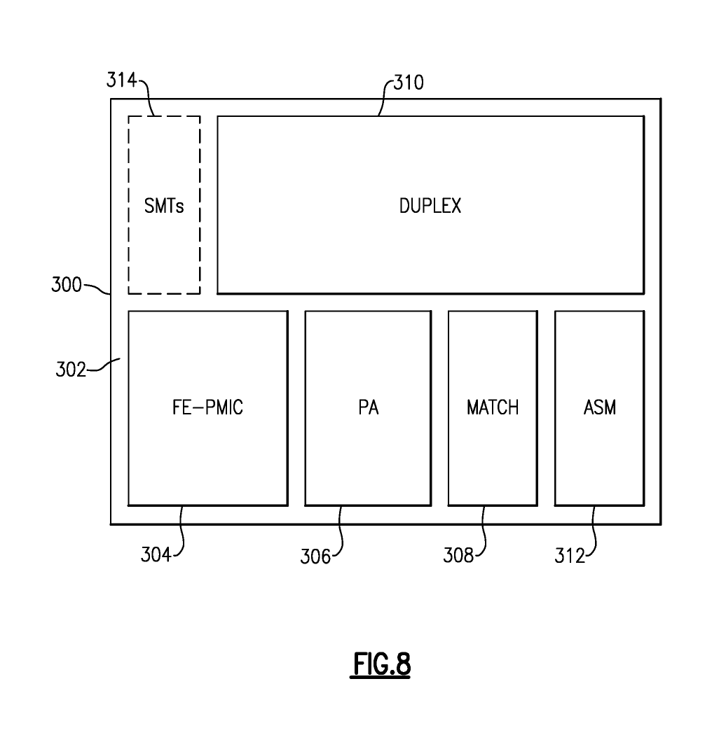

FIGS. 7A-7D schematically show non-limiting examples of implementations/configurations of PAs on one or more semiconductor die. FIG. 7A shows that in some embodiments, a PA circuit 510 and a GPIO module 530 having one or more features as described herein can be implemented on a die 700. FIG. 7B shows that in some embodiments, at least some of the GPIO module 530 can be implemented outside of the die 700 of FIG. 7A.

FIG. 7C shows that in some embodiments, a PA circuit 510 having one or more features as described herein can be implemented on a first die 700a, and a GPIO module 530 having one or more features as described herein can be implemented on a second die 700b. FIG. 7D shows that in some embodiments, at least some of the GPIO module 530 can be implemented outside of the first die 700a of FIG. 7C.

FIG. 8 shows that in some embodiments, some or all of power amplification systems (e.g., those shown in 3A-3E, 4, 5) can be implemented, wholly or partially, in a module. Such a module can be, for example, a front-end module (FEM). In the example of FIG. 7, a module 300 can include a packaging substrate 302, and a number of components can be mounted on such a packaging substrate 302. For example, an FE-PMIC component 304, a power amplifier assembly 306, a match component 308, and a duplexer assembly 310 can be mounted and/or implemented on and/or within the packaging substrate 302. Other components such as a number of SMT devices 314 and an antenna switch module (ASM) 312 can also be mounted on the packaging substrate 302. Although all of the various components are depicted as being laid out on the packaging substrate 302, it will be understood that some component(s) can be implemented over other component(s).

In some implementations, a device and/or a circuit having one or more features described herein can be included in an RF device such as a wireless device. Such a device and/or a circuit can be implemented directly in the wireless device, in a modular form as described herein, or in some combination thereof. In some embodiments, such a wireless device can include, for example, a cellular phone, a smart-phone, a hand-held wireless device with or without phone functionality, a wireless tablet, etc.

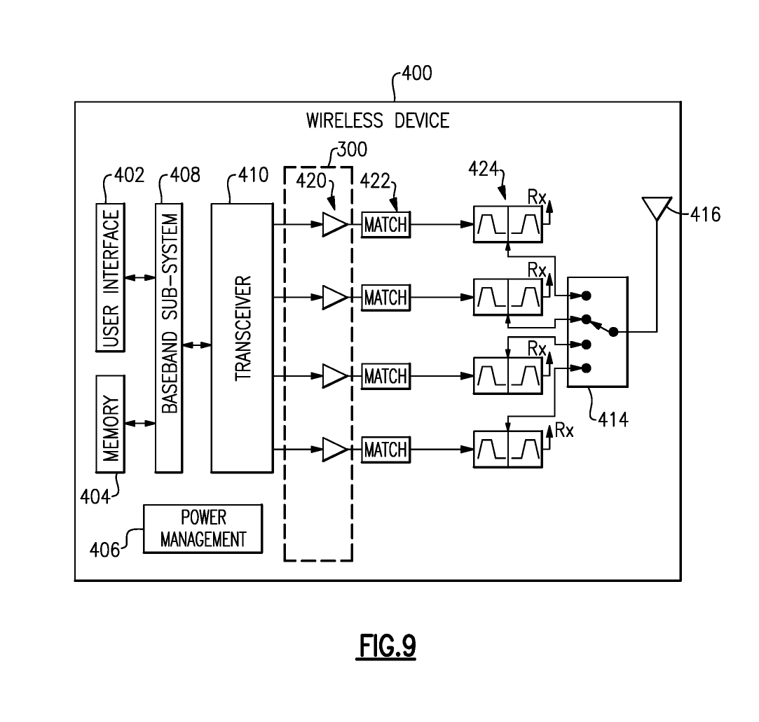

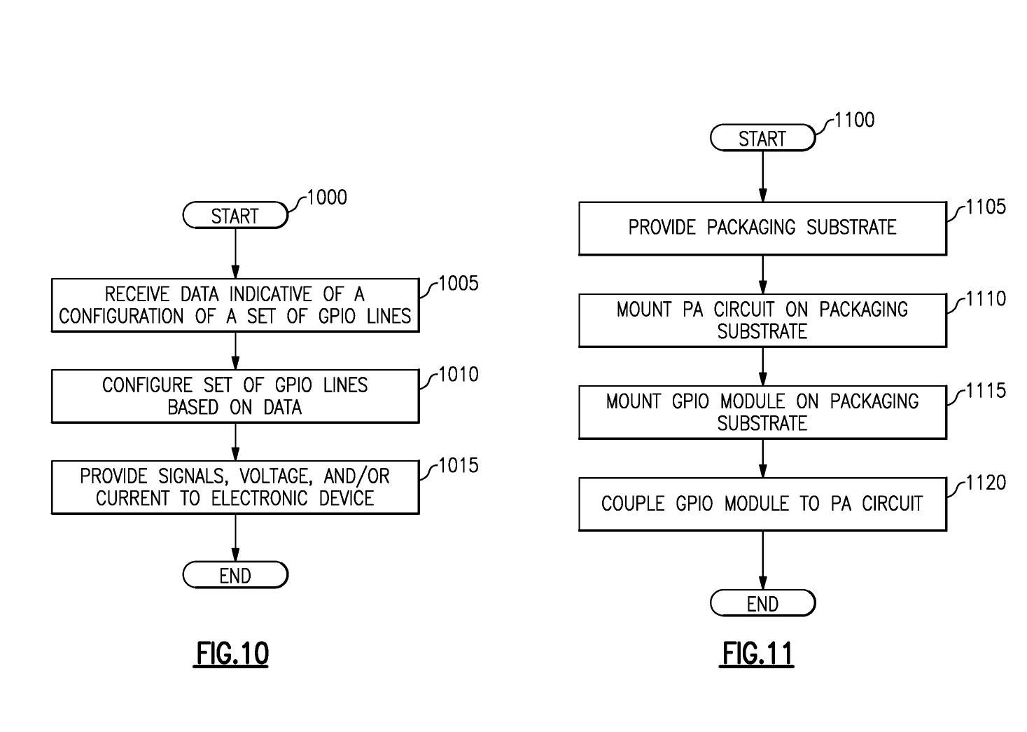

FIG. 9 depicts an example wireless device 400 having one or more advantageous features described herein. In the context of a module having one or more features as described herein, such a module can be generally depicted by a dashed box 300, and can be implemented as, for example, a front-end module (FEM).

Referring to FIG. 9, power amplifiers (PAs) 420 can receive their respective RF signals from a transceiver 410 that can be configured and operated in known manners to generate RF signals to be amplified and transmitted, and to process received signals. The PAs 420 may each include a PA circuit, a SPI module, a GPIO module, and/or a set of GPIO lines (as discussed above on conjunction with FIG. 5). In one embodiment, the PAs 420 may be MMMB PAs. The transceiver 410 is shown to interact with a baseband sub-system 408 that is configured to provide conversion between data and/or voice signals suitable for a user and RF signals suitable for the transceiver 410. The transceiver 410 can also be in communication with a power management component 406 that is configured to manage power for the operation of the wireless device 400. Such power management can also control operations of the baseband sub-system 408 and the module 300.

The baseband sub-system 408 is shown to be connected to a user interface 402 to facilitate various input and output of voice and/or data provided to and received from the user. The baseband sub-system 408 can also be connected to a memory 404 that is configured to store data and/or instructions to facilitate the operation of the wireless device, and/or to provide storage of information for the user.

In the example wireless device 400, outputs of the PAs 420 are shown to be matched (via respective match circuits 422) and routed to their respective duplexers 424. Such amplified and filtered signals can be routed to an antenna 416 through an antenna switch 414 for transmission. In some embodiments, the duplexers 424 can allow transmit and receive operations to be performed simultaneously using a common antenna (e.g., 416). In FIG. 8, received signals are shown to be routed to “Rx” paths (not shown) that can include, for example, a low-noise amplifier (LNA).

A number of other wireless device configurations can utilize one or more features described herein. For example, a wireless device does not need to be a multi-band device. In another example, a wireless device can include additional antennas such as diversity antenna, and additional connectivity features such as Wi-Fi, Bluetooth, and GPS.

As described herein, one or more features of the present disclosure can provide a number of advantages when implemented in systems such as those involving the wireless device of FIG. 9. For example, the disclosed embodiments may reduce the number of discrete logic and control signals that come from a transceiver and/or baseband processor. In another example, the disclosed embodiments may allow a PA to control the peripheral devices and/or components (e.g., electronic devices and/or components) that may be coupled to the PA and/or may be near the PA. In a further example, the disclosed embodiments may allow for greater flexibility when coupling, integrating, and/or interfacing a PA with different electronic components for different configurations and/or applications.

FIG. 10 shows a flowchart representation of a method 1000 of configuring one or more GPIO lines. In some embodiments, the GPIO lines may be part of a PA, such as an MMMB PA. In some embodiments, the method 1000 is at least partially performed by processing logic (such as the GPIO module 510 of FIG. 5), including hardware, firmware, software, or a combination thereof. In some embodiments, the method 1000 is at least partially performed by a processor executing code stored in a non-transitory computer-readable medium (e.g., a memory).

The method 1000 begins, at block 1005, with receiving data indicative of a configuration of a set of GPIO lines (e.g., one or more GPIO lines). For example, as discussed above, a PA and/or GPIO module may receive the data from a SPI module. At block 1010, the set of GPIO lines is configured based on the data. For example, one or more GPIO lines may be configured to provide/receive a current, provide/receive a voltage, and/or transmit/receive signals (e.g., binary signals, control signals, etc.), as discussed above. In one embodiment the set of GPIO lines may be configured while the PA is in operation. In another embodiment, the set of GPIO lines may be configured before the PA is in operation. Signals, voltages, and/or currents are provided to an electronic component coupled to the PA at block 1015 via the set of GPIO lines after the set of GPIO lines have been configured, as discussed above.

FIG. 11 shows a flowchart representation of a method 1100 of fabricating a PA (e.g., a PA module) having one or more features as described herein. In some embodiments, the PA may be a MMMB PA. In some embodiments, the method 1100 is at least partially performed by processing logic, including hardware, firmware, software, or a combination thereof. In some embodiments, the method 1100 is at least partially performed by a processor executing code stored in a non-transitory computer-readable medium (e.g., a memory).

The method 1100 begins, at block 1105, providing a packaging substrate. The packaging substrate may include a semiconductor die. At block 1110, a PA circuit may be mounted on the semiconductor die. For example, referring to FIG. 5, the PA circuit 510 may be mounted on the semiconductor die. At block 1115, a GPIO module may be mounted on the packaging substrate. For example, referring to FIG. 5, the GPIO module 530 may be mounted on the packaging substrate. One or more GPIO lines (e.g., wires, pins, traces, etc.) may also be formed at block 1115. The one or more GPIO lines may also be coupled to the GPIO module at block 1115. The GPIO module is optionally coupled to the PA circuit at block 1120.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A power amplifier (PA) module comprising:
a PA circuit configured to receive a radio-frequency (RF) signal; and
a general purpose input output (GPIO) module coupled to the PA circuit, the GPIO module configured to configure a set of GPIO lines to interface with an electronic component and the set of GPIO lines configured to provide one or more of a control signal, a current, or a voltage to the electronic component via the one or more GPIO lines.

2. The PA module of claim 1 wherein the control signal indicates one or more of a first voltage level of a logical high state or a second voltage level of a logical low state.

3. The PA module of claim 2 wherein the set of GPIO lines is coupled to a digital to analog converter (DAC).

4. The PA module of claim 1 wherein the current is received from a current source coupled to the set of GPIO lines.

5. The PA module of claim 1 wherein the voltage is received from a voltage source coupled to the set of GPIO lines.

6. The PA module of claim 1 wherein the set of GPIO lines is configured based on first data received via a serial peripheral interface.

7. The PA module of claim 6 wherein the first data is received while the PA module is in operation.

8. The PA module of claim 6 wherein the first data is received prior to the operation of the PA module.

9. The PA module of claim 1 wherein the electronic component comprises an antenna switching module (ASM).

10. The PA module of claim 1 wherein the electronic component comprises a band switch.

11. The PA module of claim 1 wherein the electronic component comprises a direct current to direct current converter.

12. The PA module of claim 1 wherein the electronic component comprises a bolt on PA.

13. The PA module of claim 1 wherein the PA module comprises a multimode multiband (MMMB) PA.

14. A method of operating a power amplifier (PA) module, the method comprising:
receiving first data indicative of a configuration of a set of general purpose input output (GPIO) lines of a GPIO module;
configuring the set of GPIO lines based on the first data, the set of GPIO lines being coupled to an electronic component and the set of GPIO lines configured to provide one or more of a control signal, a current, or a voltage to the electronic component via the one or more GPIO lines.

15. The method of claim 14 wherein the control signal indicates one or more of a first voltage level of a logical high state or a second voltage level of a logical low state.

16. The method of claim 15 wherein the set of GPIO lines is coupled to a digital to analog converter (DAC).

17. The method of claim 14 wherein the current is received from a current source coupled to the set of GPIO lines.

18. The method of claim 14 wherein the voltage is received from a voltage source coupled to the set of GPIO lines.

19. The method of claim 14 wherein the set of GPIO lines is configured based on first data received via a serial peripheral interface.

20-28. (canceled)

29. An electronic device comprising:
a transceiver configured to generate a radio-frequency (RF) signal;
a power amplifier (PA) module in communication with the transceiver and configured to amplify the RF signal, the PA module including a PA circuit and general purpose input output (GPIO) module configured to configure a set of GPIO lines to interface with an electronic component, the set of GPIO lines configured to provide one or more of a control signal, a current, or a voltage to the electronic component via the one or more GPIO lines; and
an antenna in communication with the PA module, the antenna configured to facilitate transmission of the amplified RF signal.

30. (canceled)
